(19) United States
(12) Patent Application Publication
(10) Pub. No.: US 2016/0061974 A1
(43) Pub. Date: Mar. 3, 2016

(54) Full-Wavefield Inversion Using Mirror Source-Receiver Geometry

(71) Applicants: Reeshidev Bansal, Spring, TX (US); Anatoly Baumstein, Houston, TX (US); Tetyana Vdovina, Houston, TX (US); Dongxing Wang, Spring, TX (US); Hongchuan Sun, Spring, TX (US)

(72) Inventors: Reeshidev Bansal, Spring, TX (US); Anatoly Baumstein, Houston, TX (US); Tetyana Vdovina, Houston, TX (US); Dongxing Wang, Spring, TX (US); Hongchuan Sun, Spring, TX (US)

(21) Appl. No.: 14/801,409

(22) Filed: Jul. 16, 2015

Related U.S. Application Data
(60) Provisional application No. 62/044,728, filed on Sep. 2, 2014.

(51) Int. Cl. G01V 1/28; G06F 17/10

(52) U.S. Cl. CPC G01V 1/282; G06F 17/10; G01V 2210/43; G01V 2210/74; G01V 2210/679

(57) ABSTRACT

Method for performing a full wavefield inversion (FWI) without simulating free-surface multiple reflections. The free-surface multiples are removed from the field gathers of seismic data, which are then used to generate a subsurface velocity model by FWI. In the FWI, the field monopole sources and receivers are replaced with dipole (actual and mirror image) sources and receivers (21) when model-simulating (23) synthetic survey data. Also, direct arrivals at the mirror receiver locations are preferably simulated (25) with the dipole sources for each shot location and added (26) to the synthetic survey data (24) for that shot location, resulting in corrected synthetic survey data (27), which is used in the FWI to generate residuals. A model update may be computed by back-propagating the residuals by injecting them at both mirror and actual receiver locations.

### CROSS-REFERENCE TO RELATED APPLICATION

This application claims the benefit of U.S. Provisional Patent Application 62/044,728, filed Sep. 2, 2014, entitled FULL-WAVEFIELD INVERSION USING MIRROR SOURCE-RECEIVER GEOMETRY, the entirety of which is incorporated by reference herein.

### FIELD OF THE INVENTION

The invention relates generally to the field of geophysical prospecting for hydrocarbons, and more particularly to geophysical data processing. Specifically, the invention is a method to invert seismic data containing source and receiver ghosts but no free-surface multiples.

### BACKGROUND OF THE INVENTION

Full wavefield inversion (FWI) is a geophysical method that is used invert seismic data to infer a subsurface model of a physical property, such as velocity, that affects propagation of seismic waves through a medium. FWI is known to estimate the subsurface properties more accurately than other inversion methods such as AVO inversion. The crux of any FWI computer algorithm can be described as follows: using a starting subsurface model, synthetic seismic data are generated by solving a wave equation using a numerical scheme (e.g., finite-difference, finite-element etc.). The synthetic seismic data are compared with the field seismic data and using the difference between the two, an error or objective function is calculated. Using the objective function, a modified subsurface model is generated which is used to simulate a new set of synthetic seismic data. This new set of synthetic seismic data is compared with the field data to generate a new objective function. This process is repeated until the objective function is satisfactorily minimized and the final subsurface model is generated. A global or local optimization method may be used to minimize the objective function and to update the subsurface model. The accuracy of any FWI method is in general dictated by its two important components: the numerical algorithm used for solving wave equation to generate synthetic seismic data and the optimization scheme. Depending on the type of optimization scheme employed, a FWI method may or may not get trapped in a local minimum while updating the subsurface model.

There are several numerical methods such as finite-difference and finite-element available for solving the wave equation. The finite-difference methods [1], which are the most popular numerical scheme for solving the wave equation, suffer from the interface error generated by the misalignment between numerical grids and numerical interfaces [2]. A majority of the FWI applications are performed with an absorbing boundary condition (ABC) on top of the subsurface model (or without invoking a free-surface boundary condition). This allows the user to generate primary reflections (primaries) and internal multiple reflections (internal multiples) without introducing free-surface (air-water or air-ground) multiples in the simulated data. These FWI workflows work with processed data that do not have free-surface multiples in them. Accurate numerical simulation of free-surface multiples is a challenging task [2]. Hence, it is preferred not to include the free-surface multiples in FWI. This is accomplished by removing the free-surface multiples from the field gathers, which are then input to FWI [3] and by not imposing a free-surface boundary condition in the synthetic seismic simulation. Without the free-surface boundary condition, however, it is not possible to accurately simulate source and receiver ghosts in the synthetic data. These are not multiple reflections, and so they are not removed from the measured data when the free-surface multiples are removed. To circumvent this problem, field gathers may be spectrally shaped such that the notches generated due to source and receiver ghosts in the spectra of reflected events are eliminated [4]. This approach, however, has two flaws: (1) it does not account for offset- or angle-dependent variation of source and receiver ghosts; (2) it does not accurately simulate the direct arrivals (source-to-receiver direct transmissions) which will also be present in the measured data. Incorrect simulation of direct arrivals may lead to erroneous FWI results. Usually direct arrivals are not included in the FWI by muting them out from the field data. In deep-water environments, the direct arrivals are usually well separated from the other parts of the wavefields (reflections/diving waves) which allows the user to mute them out from the data without damaging the arrivals which FWI uses to update the model properties. In the shallow water environments, however, direct arrivals are intermingled with the rest of the wavefields and it has not been possible to mute them without losing a significant part of the wavefield that FWI needs.

### SUMMARY OF THE INVENTION

In one embodiment, the invention is a method for prospecting for hydrocarbons using seismic survey data generated by a source and receivers deployed at locations in a survey environment with a free surface, being an air-water interface or an air-ground interface, comprising:

generating a simulation model of the survey environment wherein the air above the free surface is replaced by a padded layer topped by an absorbing boundary condition, said padded layer being a mirror image of the water or ground below the free surface;
adding actual source and receiver locations and mirror image source and receiver locations to the simulation model;
computer-simulating predicted seismic data at the actual survey receiver locations and at the mirror receiver locations in response to simultaneous activation of a source and its mirror source;
subtracting the predicted seismic data at the mirror receiver locations from the predicted seismic data at corresponding actual survey locations, resulting in adjusted predicted seismic data at the actual survey locations;
using the adjusted predicted seismic data in inverting the seismic survey data to infer a subsurface model of velocity or other physical property, wherein the inversion comprises computing a gradient of an objective function in order to determine a physical property model update, and computing the gradient comprises propagating data residuals backward in time by injecting them at both mirror and actual survey receiver locations; and
using the physical property model in prospecting for hydrocarbons.

The computer activation of source and mirror source in (b) is preferably simultaneous, i.e. performed in the same simulation, but the invention can still be performed, although less efficiently, in two separate simulations. Some embodiments of the invention include the additional step of computer-simulating direct arrivals at the mirror receiver locations in response to simultaneous activation of the source and its mirror source, which are then added to the adjusted predicted seismic data at the mirror receiver locations to generate final predictions of seismic data to be used in computing the objective function.

An accurate subsurface velocity model is essential for migrating the seismic data so that reflecting surfaces are shown at their true locations. This gives an accurate structural model of the subsurface, which is important for assessing hydrocarbon potential and for planning development and production of a resource. All practical applications of the present inventive method would be implemented using a computer, programmed according to the disclosures herein.

### BRIEF DESCRIPTION OF THE DRAWINGS

The present invention and its advantages will be better understood by referring to the following detailed description and the attached drawings in which:

FIG. 1 shows a subsurface model with the mirror geometry configuration of the present invention, wherein the model is padded on the top to accommodate mirror geometry for sources and receivers, and source and receivers are deployed at their corresponding mirror locations;

FIG. 2 is a flow chart showing basic steps in one embodiment of the present inventive method for generating synthetic seismic data during full wavefield inversion;

FIG. 3 is a flow chart showing basic steps for generating direct arrival synthetic seismic data at mirror receiver locations in one embodiment of the present invention;

FIG. 4A shows a synthetic seismic gather without correct source and receiver ghost (direct arrival is too strong), and FIG. 4B shows the synthetic seismic gather as generated using the present inventive method (has correct direct arrival).

The invention will be described in connection with example embodiments. However, to the extent that the following detailed description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

The present inventive method allows the user to accurately model and invert the direct arrivals without generating free-surface multiples in the simulated data. (Direct arrivals are seismic waves that propagate from a source directly to a receiver without reflecting from a region interface or bending.) The method also generates correct source and receiver ghosts without generating free-surface multiples.

The method introduces appropriate source and receiver ghosts without modeling free-surface multiples in the simulated data. In seismic simulation, the monopole source is replaced with a dipole source which is created by including a source signature of the opposite polarity at the mirror (reflected through the plane of the free surface) location of the original source location. Other than polarity, the source signature at a mirror location is the same as the source signature at the corresponding original location. Likewise, monopole receivers are replaced with a dipole receiver by deploying another set of receiver line at the mirror location of the original receiver line. Cunha (1993) [5] and Vigh et al. (2010 and 2011) [6, 7] briefly mention that the source and receiver ghosts can be generated by the dipole source and receivers. They, however, do not show any application of this approach in the context of full wavefield inversion.

In US Patent Application Publication 2012/0218859, Soubaras [9] describes a matched mirror migration procedure in which actual positions of detectors and fictitious mirror positions of the actual detectors are used. In US Patent Application Publication 2013/0279290, Poole [10] describes a method for de-ghosting seismic streamer data in a migrated image using migration data and mirror migration data. In US Patent Application Publication 2013/028-2292, Wang [11] describes a method for de-ghosting seismic data in a pre-migration step involving generating mirror data from the actual recorded data.

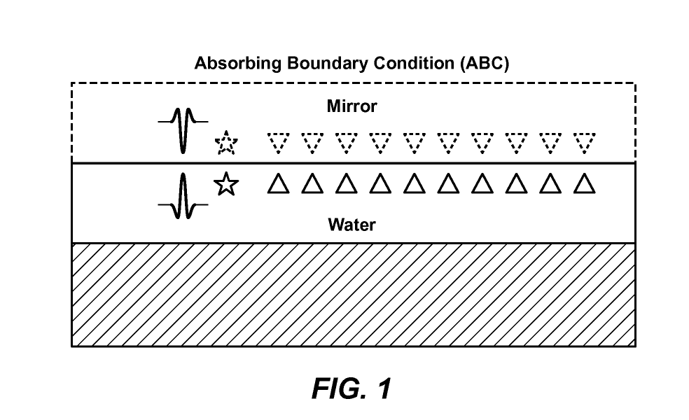

The simulation/inversion model is padded on the top to accommodate this arrangement of mirror source and receivers. Furthermore, additional padding is provided on the top of the model for the absorbing boundary condition (FIG. 1). As can be seen in the drawing, the model (of a marine survey location) is “padded” on the top to accommodate mirror geometry for sources (denoted by stars) and receivers (triangles). For purposes of the computer simulation, source and receivers are deployed at their corresponding mirror locations, with water replacing air. Polarity of source functions at mirror locations is reversed, which effectively leads to a dipole source.

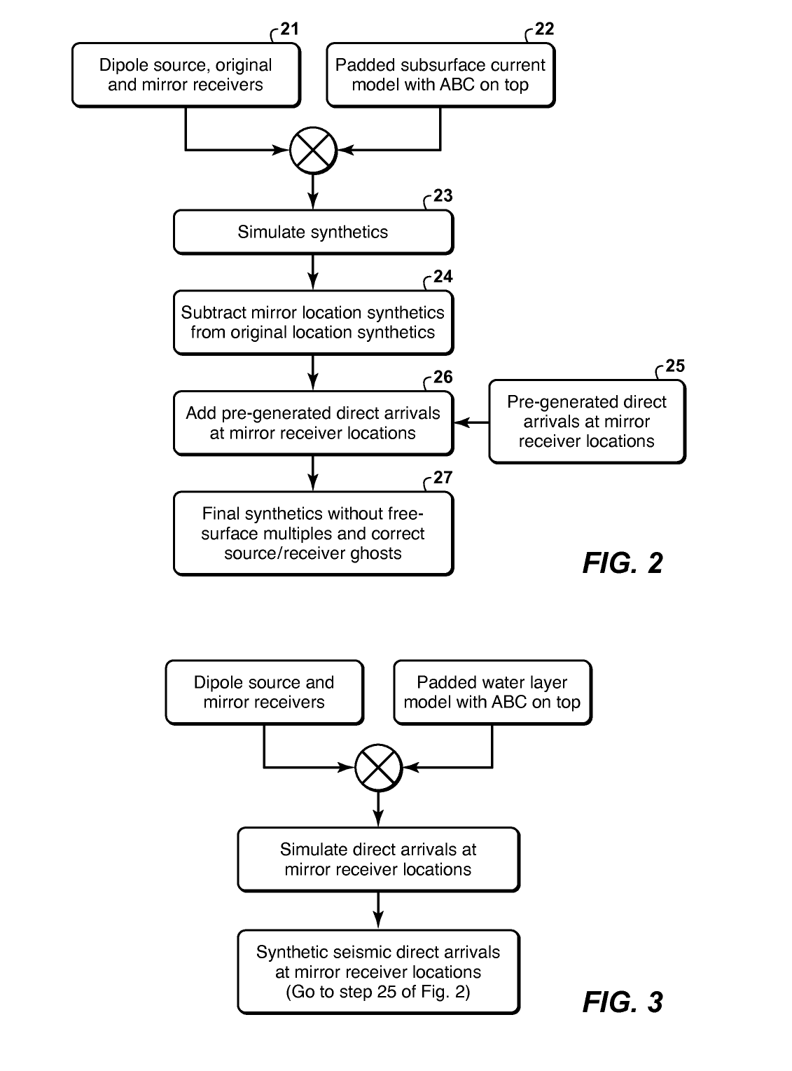

Basic steps for performing the synthetic seismic simulation, according to one embodiment of the present invention, are shown in the flow chart of FIGS. 2. 21 and 22 show the input information given to the computer simulation algorithm 23. The dipole source introduces the correct source ghost in the simulated data. At step 24, receiver ghosts are introduced by subtracting the simulated data at mirror receiver locations from the simulated data at the original receiver locations. This process, however, also introduces a receiver ghost in the simulated direct arrivals which will not be present in field seismic data. In order to remove the receiver ghosts from the direct arrivals in the synthetic seismic data, pre-simulated direct arrivals 25 in the water layers at the mirror receiver locations are added to the previously generated synthetic data in step 26. This process produces synthetic data with the correct source and receiver ghosts (27).

In a sub-optimal embodiment of the present inventive method, steps 25 and 26 may be omitted. This shortened method may work reasonably well for some data sets, for example long-offset data with a deeper target, where correct simulation of the offset-dependent ghost for deeper reflections is important.

FIG. 3 shows basic steps for performing step 25, i.e. for generating direct arrivals at the mirror receiver locations, according to one embodiment of the present invention. Direct arrival synthetics may be generated for all the shot gathers that are going to be used in the inversion. The direct arrival synthetics may thus be generated only once, at the start of the inversion. In other words, since the only propagation medium involved in the simulation in FIG. 3 is the padded water layer, the elastic properties of the medium remain fixed. This is not true for the entire model shown in FIG. 1, which is the model used for the simulation in FIG. 2, because as the inversion proceeds from one iteration to another, the model parameters below the water bottom are repeatedly updated.

In full wavefield inversion, synthetic data are compared with the field data to produce data residuals, which are back-projected into the model to compute the gradient of the objective function in model parameter space, which gives the optimal direction in that multi-dimensional space for a model update. The most correct way to perform the back projection is to inject the residual as a dipole source at both the original and the mirror receiver locations. This follows from the analysis of the objective function (for simplicity, written below for a single seismic trace) may be expressed as:

E(u)=−½(S_{R}u−S_{-R}u−d)²,

where u is the forward-simulated wavefield, d represents the recorded data, S_{R} is a sampling operator that selects the values of the simulated wavefield at the receiver locations, and S_{-R} is the sampling operator that selects the values of the simulated wavefield at the mirror receiver locations. According to the adjoint-state method [8], the gradient of the objective function may be computed by back-projecting the data residual:

$$\frac{\partial E}{\partial u} = ( {S}_{R}^{*} - {S}_{- R}^{*} ) ( {S}_{R} u - {S}_{- R} u - d ) ,$$

where the adjoint sampling operators S_{R}^{*} and S_{R}^{*} amount to injecting the residual (S_{R}u−S_{-R}u−d) at both the actual and mirror receiver locations.

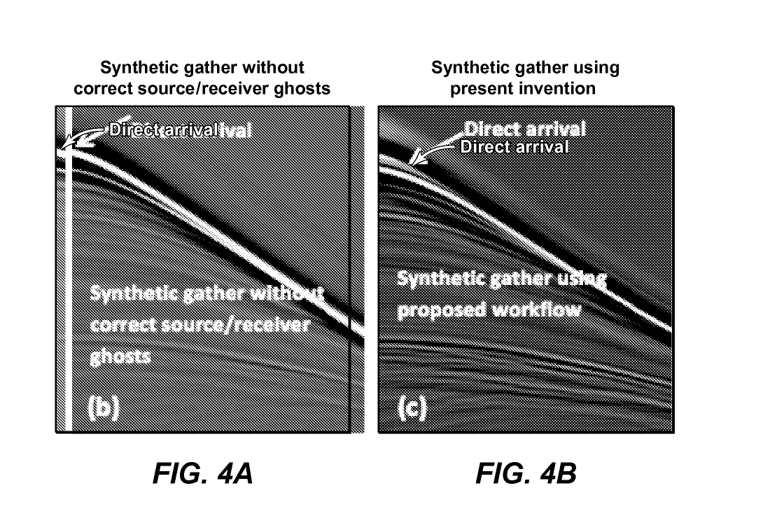

FIGS. 4A-4B compare a synthetic gather that was generated without free-surface boundary condition at the top of the model (FIG. 4A) and a synthetic gather generated according to the present inventive method (FIG. 4B). The synthetic seismic gather generated using the present inventive method (FIG. 4B) produces the same strength direct arrival events as seen in the field gather because correct source and receiver ghosts were simulated. In FIG. 4A, the direct arrival is too strong due to the absence of correct source and receiver ghosts. In FIGS. 4A-4B, the vertical axis represents depth, and horizontal position is shown on the other axis.

To illustrate the invention, it has been described as being applied to invert marine survey data, where it is probably the most advantageous. Nevertheless, the invention may also be applied to a land survey. The free interface then is the air-ground interface, and the padding in the simulation model above that interface would be a mirror image of the near-surface ground medium. In order to use the efficient embodiment of the invention in which the direct arrivals are simulated only once, at the beginning, the velocity model for the near surface layer would have to be reasonably well known in advance, or else the alternative embodiment of the invention that omits simulating direct arrivals could be used. But even in the case of water, the water velocity is often variable in the near surface, just as it is on land.

The foregoing description is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined by the appended claims.

### REFERENCES

1. Virieux, J., “P-SV wave propagation in heterogenous media: Velocity-stress finite-difference method,” Geophysics 51, 889-901 (1986).
2. Symes, W. W. and Vdovina, T., “Interface error analysis for numerical wave propagation,” Computational Geosciences 13, 363-371 (2009).
3. Verschuur, D. J., Berkhout, A. J., and Wapenaar, C.P.A., “Adaptive surface-related multiple elimination,” Geophysics 57, 1166-1177 (1992).
4. Lazaratos, S., Chikichev, I., and Wang, K., “Improving the convergence rate of full wavefield inversion using spectral shaping,” SEG Expanded Abstracts, 2428-2432 (2011).
5. Cunha, C., “Elastic modeling in discontinuous media,” Geophysics 58, 1840-1851 (1993).
6. Vigh, D. V., Starr, E. W., Elapavuluri, P., “Acoustic waveform inversion applicability on elastic data,” 72^{nd} EAGE Conference (2010).
7. Vigh, D., Kapoor, J., Jiao, Kun, “3D forward modeling for full waveform inversion,” 73rd EAGE Conference (2011).
8. Plessix, “A review of the adjoint-state method for computing the gradient of a functional with geophysical applications,” Geophys. J. Int. 167, 495-503 (2006).
9. Soubaras, “Method and device for processing seismic data,” US Patent Application Publication No. 2012/0218859.
10. Poole, “Device and method for de-ghosting variable depth streamer data,” US Patent Application Publication No. 2013/0279290.
11. Wang, “Premigration de-ghosting of seismic data with a bootstrap technique,” US Patent Application Publication No. 2013/0282292.

1. A method for prospecting for hydrocarbons using seismic survey data generated by a source and receivers deployed at locations in a survey environment with a free surface, being an air-water interface or an air-ground interface, comprising:
generating a simulation model of the survey environment wherein the air above the free surface is replaced by a padded layer topped by an absorbing boundary condition, said padded layer being a mirror image of the water or ground below the free surface;
adding actual source and receiver locations and mirror image source and receiver locations to the simulation model;
computer-simulating predicted seismic data at the actual survey receiver locations and at the mirror receiver locations in response to simultaneous activation of a source and its mirror source;
subtracting the predicted seismic data at the mirror receiver locations from the predicted seismic data at corresponding actual survey locations, resulting in adjusted predicted seismic data at the actual survey locations;
using the adjusted predicted seismic data in inverting the seismic survey data to infer a subsurface model of velocity or other physical property, wherein the inversion comprises computing a gradient of an objective function in order to determine a physical property model update, and computing the gradient comprises propagating data residuals backward in time by injecting them at both mirror and actual survey receiver locations; and
using the physical property model in prospecting for hydrocarbons.

2. A method of claim 1, wherein the objective function quantitatively measures misfit between the seismic survey data and the adjusted predicted seismic data, and the gradient of the objective function is computed in multi-dimensional physical property model parameter space.

3. The method of claim 1, wherein a data residual may be expressed as
S_{R}u−S_{-R}u−d
where u is a wavefield generated by the computer simulation, d represents the adjusted predicted seismic data, S_{R} is a sampling operator that selects values of the simulated wavefield at the actual survey receiver locations, and S_{-R} is a sampling operator that selects values of the simulated wavefield at the mirror receiver locations.

4. The method of claim 3, wherein injecting the data residuals at both actual and mirror survey receiver locations is performed by operating on the data residuals with adjoint sampling operators S_{R}^{*} and S_{-R}^{*}, respectively.

5. The method of claim 1, further comprising:
computer-simulating direct arrivals at the mirror receiver locations in response to simultaneous activation of the source and its mirror source;
and wherein using the adjusted predicted seismic data in inverting the seismic survey data comprises generating final predictions of seismic data at each survey location by summing the adjusted predicted seismic data and the simulated direct arrival for the mirror receiver location corresponding to the survey location, and then using final predictions in the inverting.

6. The method of claim 5, further comprising generating final predictions of seismic data for a plurality of survey source locations.

7. The method of claim 6, wherein the inverting the seismic survey data to infer a subsurface model is an iterative inversion process, and the computer-simulation of direct arrivals at the mirror receiver locations is performed only once for each source location to be used in the inversion, in recognition that only the padding part of the simulation model is used in said simulation of direct arrivals, and the padding's physical properties are known.

8. The method of claim 1, wherein the source and the mirror source have source signatures of opposite polarity in the computer-simulating of predicted seismic data.

9. The method of claim 1, wherein the inverting the seismic survey data to infer a subsurface model is full wavefield inversion.

10. A non-transitory computer usable medium having a computer readable program code embodied therein, said computer readable program code adapted to be executed to implement a method for simulating seismic survey data generated by a seismic source and receivers deployed at locations in a survey environment with a free surface, being an air-water interface or an air-ground interface, said method comprising:
generating a simulation model of the survey environment wherein the air above the free surface is replaced by a padded layer topped by an absorbing boundary condition, said padded layer being a mirror image of the water or ground below the free surface;
adding actual source and receiver locations and mirror image source and receiver locations to the simulation model;
computer-simulating predicted seismic data at the actual survey receiver locations and at the mirror receiver locations in response to simultaneous activation of a source and its mirror source;
subtracting the predicted seismic data at the mirror receiver locations from the predicted seismic data at corresponding actual survey locations, resulting in adjusted predicted seismic data at the actual survey locations;
computer-simulating direct arrivals at the mirror receiver locations in response to simultaneous activation of the source and its mirror source; and
generating final predictions of seismic data at each survey receiver location by summing the adjusted predicted seismic data and the simulated direct arrival for the mirror receiver location corresponding to the survey receiver location.

11. The non-transitory computer usable medium of claim 10, wherein the computer readable program code further includes code to implement a method for obtaining a subsurface model comprising:
using the final predicted seismic data to perform full wavefield inversion of the seismic survey data, with free-surface multiple reflections removed, to generate a subsurface model of velocity or other physical property, wherein the inversion comprises computing a gradient of an objective function in order to determine a physical property model update, and computing the gradient comprises propagating data residuals backward in time by injecting them at both mirror and actual survey receiver locations.

12. The non-transitory computer usable medium of claim 11, wherein the computer readable program code further includes code to implement a method for generating a subsurface image comprising:
using the subsurface model to migrate the seismic survey data to generate an image of the subsurface.

13. The method of claim 1, further comprising, before the inverting of the seismic survey data, removing free-surface multiple reflections from the seismic survey data.

14. The method of claim 13, further comprising applying spectral shaping to the seismic survey data with free-surface multiple reflections removed.

15. The method of claim 1, wherein the computer simulating is performed using a finite-difference or finite-element numerical scheme.
